(19) United States
(12) Patent Application Publication
(10) Pub. No.: US 2025/0138398 A1
(43) Pub. Date: May 1, 2025

(54) REFLECTIVE MODULE AND CAMERA MODULE INCLUDING THE SAME

(71) Applicant: Samsung Electro-Mechanics Co., Ltd., Suwon-si (KR)

(72) Inventors: Ji Buem CHUN, Suwon-si (KR); Hong Joo LEE, Suwon-si (KR); Nam Ki PARK, Suwon-si (KR); Bo Sung SEO, Suwon-si (KR)

(73) Assignee: Samsung Electro-Mechanics Co., Ltd., Suwon-si (KR)

(21) Appl. No.: 18/896,325

(22) Filed: Sep. 25, 2024

(30) Foreign Application Priority Data
Nov. 1, 2023 (KR) 10-2023-0148862

(51) Int. Cl. G03B 17/17; G02B 27/64; G03B 5/00; G03B 13/36

(52) U.S. Cl. CPC G03B 17/17; G02B 27/646; G03B 5/00; G03B 13/36; G03B 2205/003; G03B 2205/0069

(57) ABSTRACT

A reflective module is provided. The reflective module includes a housing; a rotating holder accommodated in the housing; a reflective holder, disposed on the rotating holder, and on which a first magnetic material and a reflective member configured to change a path of incident light are disposed; and a driving unit configured to generate a driving force to rotate the reflective member, wherein the driving unit includes a first driving magnet disposed on the rotating holder, and a first driving coil disposed on the housing, and wherein the first driving magnet faces the first driving coil in a first direction, and faces the first magnetic material in a second direction different from the first direction.

### CROSS-REFERENCE TO RELATED APPLICATIONS

This application claims the benefit under 35 USC § 119(a) of Korean Patent Application No. 10-2023-0148862 filed on Nov. 1, 2023, in the Korean Intellectual Property Office, the entire disclosure of which is incorporated herein by reference for all purposes.

### BACKGROUND

### 1. Field

The following description relates to a reflective module and a camera module including the same.

### 2. Description of Related Art

Camera modules provided in mobile devices are manufactured to have a degree of performance comparable to the performance of typical cameras. For example, mobile devices may implement a camera module in which an autofocusing operation, an optical image stabilization operation, a zoom operation, and the like are provided.

Additionally, recent mobile camera modules utilize a reflector to sufficiently secure an overall length (or a total track length). This structure has an advantage of increasing an optical path without increasing or reducing a length of the camera module, thereby enabling implementation of a high zoom magnification.

Camera modules including a reflector may be commonly configured to rotate the reflector during optical image stabilization. However, there may be spatial limitations because, around a relatively small reflector, components that provide rotational driving force to the reflector and components that stably support the driving of the reflector should be disposed.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflective module includes a housing; a rotating holder accommodated in the housing; a reflective holder on which a first magnetic material and a reflective member configured to change a path of incident light are disposed; and a driving unit configured to generate a driving force to rotate the reflective member, wherein the driving unit comprises a first driving magnet disposed on the rotating holder, and a first driving coil disposed on the housing, and wherein the first driving magnet faces the first driving coil in a first direction, and faces the first magnetic material in a second direction different from the first direction.

The reflective holder may be disposed on the rotating holder.

The first direction in which the first driving magnet and the first driving coil face each other, and the second direction in which the first driving magnet and the first magnetic material face each other may be perpendicular to each other.

The first driving coil may include two coils spaced apart in a length direction of the first driving magnet.

The reflective module may further include a first ball group disposed between the housing and the rotating holder, wherein the first ball group may include a rotation axis ball that forms a first axis, which is a rotation axis of the rotating holder, and a plurality of guide balls spaced apart from the rotation axis ball and configured to support a rotation of the rotating holder.

The first driving magnet and the first driving coil may be disposed between the rotation axis ball and the plurality of guide balls to be biased toward the rotation axis ball.

The driving unit may include a second driving magnet disposed on the reflective holder, and a second driving coil disposed on the housing.

The reflective holder may further include an extension portion that extends between the rotating holder and the housing, and the second driving magnet is disposed on the extension portion.

The reflective module may further include a second ball group disposed between the rotating holder and the reflective holder, wherein the second ball group comprises two ball members spaced apart in a direction of a second axis, which is a rotation axis of the reflective holder.

The rotating holder may be supported by the housing in the first direction, and the reflective holder may be supported by the rotating holder in the second direction different from the first direction.

In a general aspect, a camera module includes a housing; a reflective module accommodated in the housing, and including a reflective member configured to change a path of incident light; and a lens module accommodated in the housing, and including at least one lens disposed in a direction, parallel to an optical axis, wherein the reflective module includes a reflective holder on which the reflective member is disposed, and a rotating holder on which the reflective holder is disposed, and wherein a magnet, configured to generate an attractive force with regard to the reflective holder in a first direction, parallel to the optical axis, and configured to generate an attractive force with regard to the housing in a second direction, parallel to a first axis, perpendicular to the optical axis, is disposed on the rotating holder.

The magnet may face a first magnetic material in the first direction, parallel to the optical axis, and faces a first yoke in the second direction, parallel to the first axis.

The first magnetic material may be a pulling yoke that is disposed on the reflective holder.

The magnet may face a coil in the second direction, parallel to the first axis.

The rotating holder may be configured to rotate about the first axis, wherein a rotation axis ball that forms the first axis and a plurality of guide balls spaced apart from the rotation axis ball may be disposed between the rotating holder and the housing, and wherein the magnet may be disposed between the rotation axis ball and the plurality of guide balls to be biased toward the rotation axis ball in a direction of the optical axis.

The reflective holder may be configured to rotate about a second axis, perpendicular to the optical axis and the first axis, and wherein a plurality of ball members spaced apart in a direction of the second axis may be disposed between the reflective holder and the rotating holder.

The lens module may be configured to move in a direction of the optical axis, and a plurality of ball members that support a movement of the lens module in the direction of the optical axis may be disposed between the lens module and the housing.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of an example camera module, in accordance with one or more embodiments.

FIG. 3 illustrates a perspective view of an example camera module, from which a case is separated, in accordance with one or more embodiments.

FIG. 4 illustrates an exploded perspective view of an example reflective module, in accordance with one or more embodiments.

FIG. 5 illustrates a cross-sectional view of FIG. 1, taken along line I-I′.

FIG. 6 illustrates a cross-sectional view of FIG. 1, taken along line II-II′.

FIG. 7 illustrates a bottom view of a rotating holder, in accordance with one or more embodiments.

FIG. 8 illustrates an exploded perspective view of a housing and a lens module, in accordance with one or more embodiments.

FIG. 9 illustrates an exploded perspective view of a lens module, in accordance with one or more embodiments.

FIG. 10 illustrates an exploded perspective view of a housing and an example circuit board, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

In addition, in the following description, expressions such as upward, on, upper portion, downward, below, lower portion, lateral, side surface, forward, front, rearward, rear, or the like may be expressed based on the direction illustrated in the drawings, and it should be noted in advance that when a direction of an object changes, it may be expressed differently.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more examples may provide a camera module which has a structure with an improved degree of freedom of implementation.

In the one or more examples, a first axis or a first axial direction refers to an X-axis or an X-axial direction of the drawings, a second axis or a second axial direction refers to a Y-axis or a Y-axial direction of the drawings, and an optical axis (third axis) or an optical axial direction (third axial direction) may refer to a Z-axis or a Z-axial direction of the drawings. Additionally, the first axis may be a direction, perpendicular to the optical axis, and the second axis may be a direction, perpendicular to both the optical axis and the first axis.

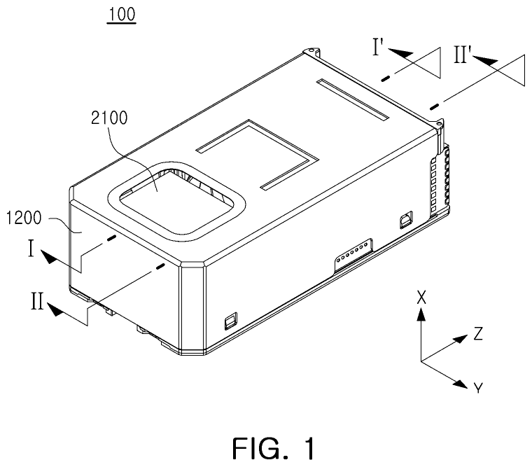

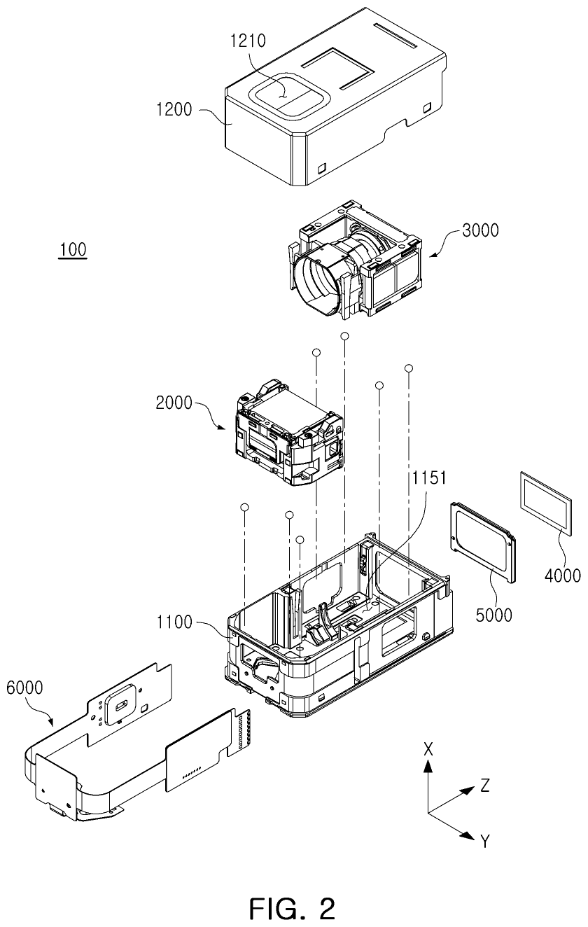

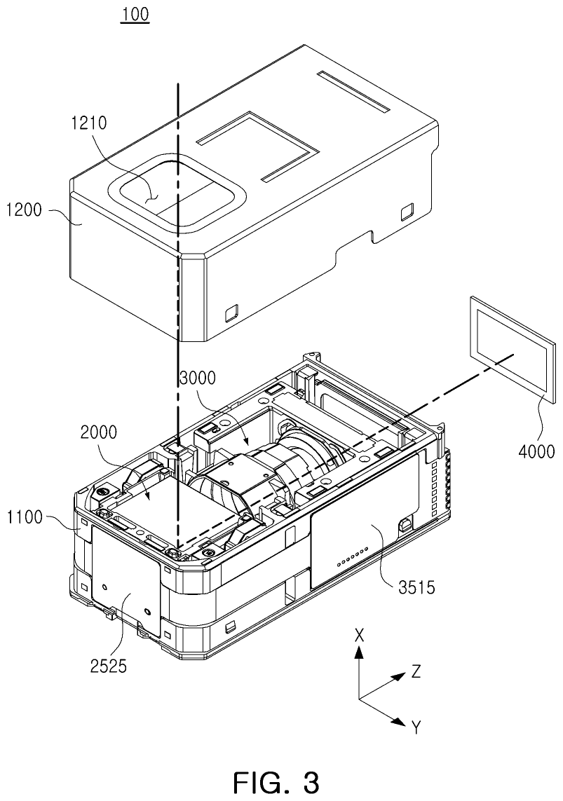

FIG. 1 illustrates a perspective view of an example camera module, in accordance with one or more embodiments, FIG. 2 is an exploded perspective view of an example camera module, in accordance with one or more embodiments, and FIG. 3 is a perspective view of a camera module, from which a case is separated, in accordance with one or more embodiments.

A camera module 100, in accordance with one or more embodiments, may be a folded (or foldable) camera module configured to change a path of incident light at least once. The camera module 100, in accordance with one or more embodiments, may have a relatively long overall length.

Referring to FIG. 1, FIG. 2, and FIG. 3, the camera module 100 may include a housing 1100, a case 1200, a reflective module 2000, a lens module 3000, and an image sensor 4000.

The housing 1100 may be a box-shaped member that is opened in an upward direction, and may have an internal space.

At least one of the reflective module 2000 or the lens module 3000 may be accommodated in the internal space of the housing 1100. In an embodiment, the reflective module 2000 and the lens module 3000 may be accommodated together in the internal space of the housing 1100. In another embodiment, the reflective module 2000 and the lens module 3000 may be accommodated in the internal space of the housing 1100, separately provided.

The reflective module 2000 and the lens module 3000 may move relative to the housing 1100 while accommodated in the internal space of the housing 1100. Accordingly, a plurality of ball members may be disposed between the reflective module 2000 and the housing 1100, and between the lens module 3000 and the housing 1100. Details related thereto will be provided later.

The image sensor 4000 and the case 1200 may be coupled to an external side of the housing 1100.

The image sensor 4000 may be coupled to one side surface of the housing 1100 in a length direction. Although not illustrated in the drawings, the image sensor 4000 may be coupled to the housing 1100 while being mounted on a substrate.

The case 1200 may be coupled to housing 1100 to cover the internal space of housing 1100. In an embodiment, the case 1200 may cover an open upper portion and three side surfaces of the housing 1100, except for a bottom surface of the housing 1100 and the one side surface of the housing 1100 to which the image sensor 4000 is coupled. A circuit board 6000 on which some of a driving unit of the reflective module 2000 and some of a driving unit of the lens module 3000 are arranged may be coupled to the remaining three side surfaces of the housing 1100, and the circuit board 6000 may also be covered by the case 1200. Components accommodated in the internal space of the housing 1100 may be separated from the outside by the case 1200.

The case 1200 may include an opening 1210 through which light is incident. Light reflected from an external subject may be incident on the camera module 100 through the opening 1210. In an embodiment, the opening 1210 may overlap the reflective module 2000. Therefore, light passing through the opening 1210 may be incident on the reflective module 2000.

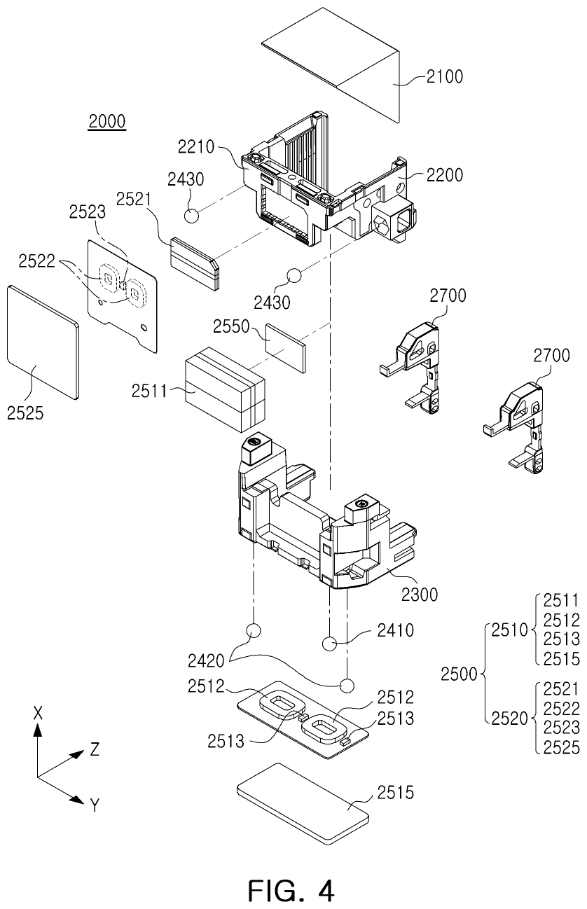

Referring to FIG. 4, the reflective module 2000 may include a reflective member 2100 that reflects or refracts light to change a path thereof. In an embodiment, the opening 1210 described above may overlap the reflective member 2100. The reflective member 2100 may change a path of incident light by approximately 90 degrees. The incident light may enter the lens module 3000 through the reflective member 2100.

The lens module 3000 may include one or more lenses that are arranged in an optical axial direction (Z-axial direction). Light incident on the lens module 3000 may be refracted while passing through the one or more lenses, and may finally reach the image sensor 4000.

An opening 1151 may be formed on one side surface of the housing 1100, in a length direction, to which the image sensor 4000 is coupled. The image sensor 4000 may be exposed to the internal space of the housing 1100 through the opening 1151 to directly face the lens module 3000. Therefore, light passing through the lens module 3000 may be incident on the image sensor 4000.

The image sensor 4000 may generate an electrical signal corresponding to light incident on the image sensor 4000, to convert the incident light into image information.

As illustrated in FIG. 2, a filter 5000 may be disposed between the lens module 3000 and the image sensor 4000. In an embodiment, the filter 5000 may be an infrared cut-off filter blocking light in an infrared wavelength range.

The camera module 100, in accordance with one or more embodiments, may have an optical image stabilization operation and an autofocusing operation.

The optical image stabilization operation of the camera module 100 may be implemented through relative movement of the reflective member 2100 with respect to the housing 1100. When optical image stabilization is performed, the reflective member 2100 may rotate by a predetermined angle based on a plurality of rotation axes. The plurality of rotation axes may be a first axis (X-axis), perpendicular to the optical axis, and a second axis (Y-axis), perpendicular to both the optical axis and the first axis.

The autofocusing operation of the camera module 100 may be implemented through relative movement of at least one lens with respect to the housing 1100. When an autofocusing operation is performed, the at least one lens may move in the optical axial direction.

In another embodiment, the camera module 100 may additionally have a zoom operation in addition to the operations described above.

Hereinafter, detailed configurations of the reflective module 2000 and the lens module 3000 of the camera module 100, in accordance with one or more embodiments, will be described in detail.

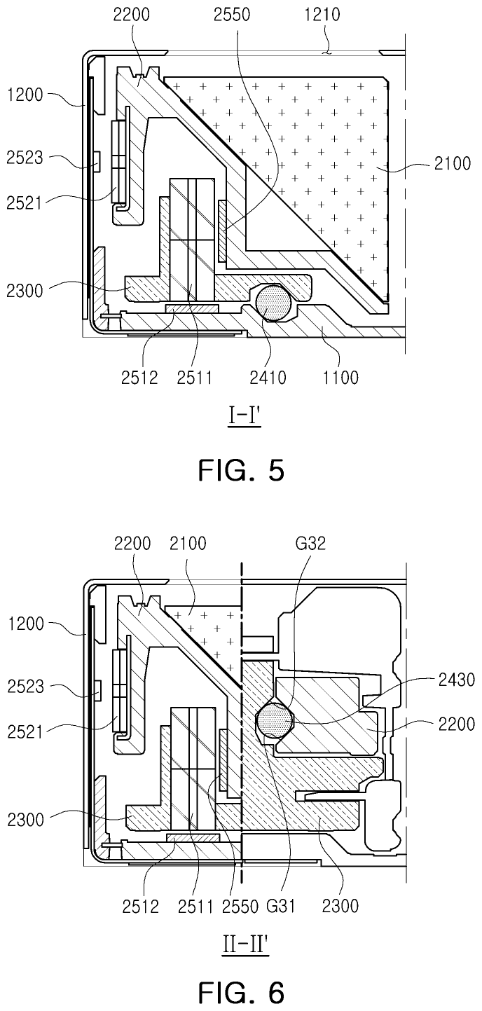

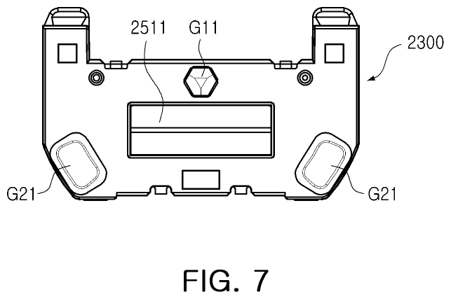

FIG. 4 is an exploded perspective view of a reflective module, in accordance with one or more embodiments, FIG. 5 is a cross-sectional view of FIG. 1, taken along line I-I′, FIG. 6 is a cross-sectional view of FIG. 1, taken along line II-II′, and FIG. 7 is a bottom view of a rotating holder, in accordance with one or more embodiments.

A reflective module 2000, in accordance with one or more embodiments, may include a reflective member 2100, a reflective holder 2200, and a rotating holder 2300. The reflective member 2100 may be accommodated in the reflective holder 2200, and the reflective holder 2200 may be disposed on the rotating holder 2300 with the reflective member 2100 mounted thereon. The rotating holder 2300 may be accommodated in an internal space of a housing 1100 with the reflective holder 2200 accommodated therein.

Additionally, the reflective module 2000 may include a support member 2700 coupled to the rotating holder 2300 with the reflective holder 2200 accommodated in the rotating holder 2300. The support member 2700 may operate as a stopper that prevents the reflective holder 2200 from being separated from the rotating holder 2300.

The support member 2700 may be coupled to both sides of the rotating holder 2300 in a length direction. The support member 2700 may be formed in a ‘c’ shape, and may be coupled to the rotating holder 2300 while surrounding a portion of the reflective holder 2200. The support member 2700 may be disposed at an interval from a portion of the reflective holder 2200 surrounded by the support member 2700, not to interfere with rotation of the reflective holder 2200.

Additionally, the support member 2700 may be provided as a configuration to which a damping member is coupled. The damping member may absorb shock and alleviate noise caused by collision with a counterpart member when the reflective holder 2200 and the rotating holder 2300 rotate.

The reflective module 2000 may include a driving unit 2500 that generates a driving force to rotate the reflective member 2100.

The driving unit 2500 may include a first driving unit 2510 that rotates the reflective member 2100 about the first axis (X-axis), and a second driving unit 2520 that rotates the reflective member 2100 about the second axis (Y-axis).

In an embodiment, the first driving unit 2510 may generate a driving force to rotate the rotating holder 2300 about the first axis (X-axis). Since the reflective holder 2200 may be accommodated in the rotating holder 2300, when the rotating holder 2300 rotates, the reflective holder 2200 may rotate together with the rotating holder 2300. Additionally, since the reflective member 2100 may be accommodated in the reflective holder 2200, when the rotating holder 2300 rotates, the reflective member 2100 may also rotate together with the rotating holder 2300. The second driving unit 2520 may generate a driving force to rotate the reflective holder 2200 about the second axis (Y-axis). Since the reflective member 2100 may be accommodated in the reflective holder 2200, when the reflective holder 2200 rotates, the reflective member 2100 may rotate together with the reflective holder 2200.

The first driving unit 2510 may include a first driving magnet 2511 and a first driving coil 2512, arranged to face each other. In an embodiment, the first driving magnet 2511 may be disposed on the rotating holder 2300, and the first driving coil 2512 may be mounted on a circuit board 6000, and may be disposed on a bottom surface of the housing 1100. The first driving magnet 2511 may partially face the first driving coil 2512 in a state disposed on the rotating holder 2300. For example, a portion of the first driving magnet 2511 may be exposed through a bottom surface of the rotating holder 2300 to face the first driving coil 2512, and the first driving magnet 2511 and the first driving coil 2512 may face each other in a first axial direction (X-axial direction).

In an example, a portion of the first driving magnet 2511 facing the first driving coil 2512 may be magnetized to have an N pole (or S pole), a neutral region, and an S pole (or N pole) in sequence.

In an example, the first driving magnet 2511 may face two first driving coils 2512. In an embodiment, the first driving magnet 2511 may have a bar shape, and the two first driving coils 2512 may be spaced apart in a length direction of the first driving magnet 2511.

The first driving magnet 2511 and the two first driving coils 2512 may generate driving forces in a direction perpendicular to a direction facing each other through electromagnetic interaction. In this example, directions of the driving forces generated by the two first driving coils 2512 and the first driving magnet 2511 may be opposite to each other. The rotating holder 2300 may rotate about the first axis (X-axis) by resultant force thereof.

A first ball group (2410 and 2420) may be disposed between the rotating holder 2300 and the housing 1100. The first ball group (2410 and 2420) may include one rotation axis ball 2410 and two guide balls 2420.

A rotation axis ball 2410 may provide a rotation axis of the rotating holder 2300. In an example, the rotation axis ball 2410 may form the first axis (X-axis), and the first axis (X-axis) may pass through the rotation axis ball 2410.

The rotation axis ball 2410 may be accommodated in first and second guide grooves G11 and G12 provided in the rotating holder 2300 and the housing 1100. The rotation axis ball 2410 may be supported in at least three points in any one of the first and second guide grooves G11 and G12 such that a position thereof is fixed. The rotation axis ball 2410 may form a rotation axis while rotating in place in a state accommodated in the first and second guide grooves G11 and G12.

A guide ball 2420 may be spaced apart from the rotation axis ball 2410. The guide ball 2420 may be accommodated in third and fourth guide grooves G21 and G22 provided in the rotating holder 2300 and the housing 1100. One of the third and fourth guide grooves G21 and G22 may have a curved or straight line extending in a circumferential direction of a circle approximately centered on the first axis (X-axis), e.g., in a rotation direction of the rotating holder 2300. The guide ball 2420 may be supported by at least two points in one of the third and fourth guide grooves G21 and G22, and may be supported by one point in the other thereof. The guide ball 2420 may support rotation of the rotating holder 2300 while rolling in a state accommodated in the third and fourth guide grooves G21 and G22.

The first driving magnet 2511 may be disposed between the rotation axis ball 2410 and the guide ball 2420. In an embodiment, the first driving magnet 2511 may be disposed close to (or biased toward) the rotation axis ball 2410 in the optical axial direction between the rotation axis ball 2410 and the guide ball 2420, and the first driving coil 2512 may also be disposed closer to the rotation axis ball 2410 to face the first driving magnet 2511. According to this structure, as a point of generation of a driving force formed by the first driving magnet 2511 and the first driving coil 2512 moves near the first axis (X-axis), which may be a rotation axis, since a rolling motion friction force of the guide ball 2420 may be relatively reduced, it may be advantageous for smooth rotation of the rotating holder 2300.

The first driving unit 2510 may include a first position sensor 2513 disposed to face the first driving magnet 2511. The first position sensor 2513 may be mounted on the circuit board 6000 together with the first driving coil 2512, and may be disposed on the bottom surface of the housing 1100.

The first position sensor 2513 may be a magnetic sensor that detects a change in magnetic flux passing through the first position sensor 2513 to sense a position of the first driving magnet 2511.

The first position sensor 2513 may face a neutral region of the first driving magnet 2511. When the first position sensor 2513 is provided as a plurality of first position sensors 2513, at least a portion of the plurality of first position sensors 2513 may face the neutral region of the first driving magnet 2511.

Additionally, the first driving unit 2510 may include a first yoke 2515 disposed to face the first driving magnet 2511. The first yoke 2515 may be disposed to cover an external side of the circuit board 6000. Specifically, the first yoke 2515 may be disposed to cover a surface of the circuit board 6000, opposite to a surface on which the first driving coil 2512 and the first position sensor 2513 are mounted.

The first yoke 2515 may be formed of a magnetic material. The first yoke 2515 may focus magnetic flux of the first driving magnet 2511, and the first yoke 2515 may generate magnetic attraction, together with the first driving magnet 2511. In an example, the first yoke 2515 may have an operation of a pulling yoke. The rotating holder 2300 may be supported in close contact with the housing 1100 due to the magnetic attraction of the first yoke 2515 and the first driving magnet 2511. The magnetic attraction may occur in the first axial direction, which may be a direction in which the first yoke 2515 and the first driving magnet 2511 face each other, and the rotating holder 2300 may be supported by the housing 1100 in the first axial direction.

The second driving unit 2520 may include a second driving magnet 2521 and a second driving coil 2522, arranged to face each other. In an embodiment, the second driving magnet 2521 may be disposed on the reflective holder 2200, and the second driving coil 2522 may be mounted on the circuit board 6000, and may be disposed on one side surface of the housing 1100. The second driving magnet 2521 may face the second driving coil 2522 in a state disposed on the reflective holder 2200. Accordingly, the reflective holder 2200 may include a portion (hereinafter referred to as an extension portion 2210) that extends between the rotating holder 2300 and one side surface of the housing 1100. The second driving magnet 2521 may be disposed in the extension portion 2210, and the second driving magnet 2521 and the second driving coil 2522 may face each other in the optical axial direction (Z-axial direction).

The second driving magnet 2521 may be magnetized such that a surface thereof facing the second driving coil 2522 has an N pole (or S pole), a neutral region, and an S pole (or N pole) in sequence.

The second driving magnet 2521 may face two second driving coils 2522. In an embodiment, the second driving magnet 2521 may have a bar shape, and the two second driving coils 2522 may be spaced apart in a length direction of the second driving magnet 2521.

The second driving magnet 2521 and the two second driving coils 2522 may generate driving forces in a direction perpendicular to a direction facing each other through electromagnetic interaction. In this example, directions of the driving forces formed by the two second driving coils 2522 and the second driving magnet 2521 may be opposite to each other. The reflective holder 2200 may rotate about the second axis (Y-axis) based on a resultant force thereof.

In another embodiment, a position of the second driving unit 2520 may be changed. For example, the second driving magnet 2521 and the second driving coil 2522 may be arranged to face each other in the second axis (Y-axis) direction. In this example, positions of the second driving magnet 2521 and the second driving coil 2522, as well as a position of a second position sensor 2523 and a position of a second yoke 2525, which will be described later, may also be changed.

A second ball group 2430 may be disposed between the reflective holder 2200 and the rotating holder 2300. The second ball group 2430 may include two ball members 2430 spaced apart in the second axis (Y-axis) direction.

The two ball members 2430 may provide a rotation axis of the reflective holder 2200. For example, the two ball members 2430 may form the second axis (Y-axis), and the second axis (Y-axis) may pass through the two ball members 2430.

The two ball members 2430 may be accommodated in fifth and sixth guide grooves G31 and G32 provided in the reflective holder 2200 and the rotating holder 2300. The two ball members 2430 may be supported in at least three points in any one of the fifth and sixth guide grooves G31 and G32 such that positions thereof are fixed. The two ball members 2430 may form a rotation axis while rotating in place in a state accommodated in the fifth and sixth guide grooves G31 and G32.

The second driving unit 2520 may include a second position sensor 2523 disposed to face the second driving magnet 2521. The second position sensor 2523 may be mounted on the circuit board 6000 together with the second driving coil 2522, and may be disposed on one side surface of the housing 1100.

The second position sensor 2523 may be a magnetic sensor that detects a change in magnetic flux passing through the second position sensor 2523 to sense a position of the second driving magnet 2521.

The second position sensor 2523 may face a neutral region of the second driving magnet 2521. When the second position sensor 2523 is provided as a plurality of second position sensors 2523, at least a portion of the plurality of second position sensors 2523 may face the neutral region of the second driving magnet 2521.

Additionally, the second driving unit 2520 may include a second yoke 2525 disposed to face the second driving magnet 2521. The second yoke 2525 may be disposed to cover the external side of the circuit board 6000. Specifically, the second yoke 2525 may be disposed to cover a surface of the circuit board 6000, opposite to a surface on which the second driving coil 2522 and the second position sensor 2523 are mounted.

The second yoke 2525 may be formed of a magnetic material, and may focus magnetic flux of the second driving magnet 2521.

The reflective holder 2200 may be supported on the rotating holder 2300. In an embodiment, the reflective holder 2200 may include a pulling yoke (or a first magnetic material) 2550. The pulling yoke 2550 may be disposed to face the first driving magnet 2511 disposed on the rotating holder 2300. The pulling yoke 2550 may generate magnetic attraction, together with the first driving magnet 2511. The reflective holder 2200 may be supported in close contact with the rotating holder 2300 due to the magnetic attraction of the pulling yoke 2550 and the first driving magnet 2511. The magnetic attraction may occur in the optical axial direction, which may be a direction in which the pulling yoke 2550 and the first driving magnet 2511 face each other, and the reflective holder 2200 may be supported on the rotating holder 2300 in the optical axial direction.

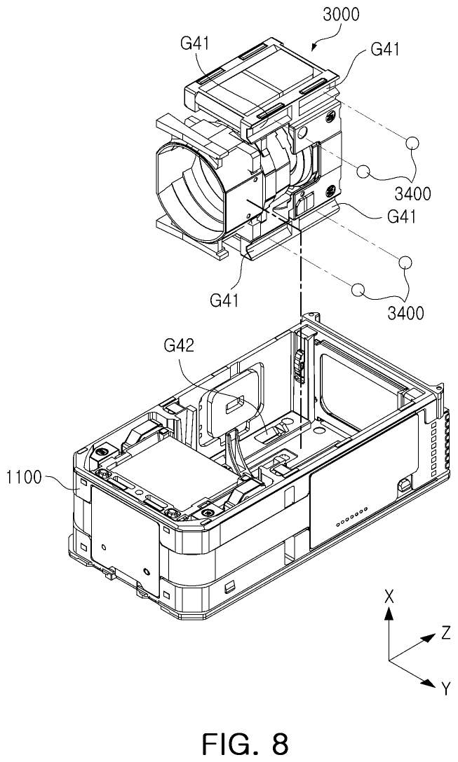

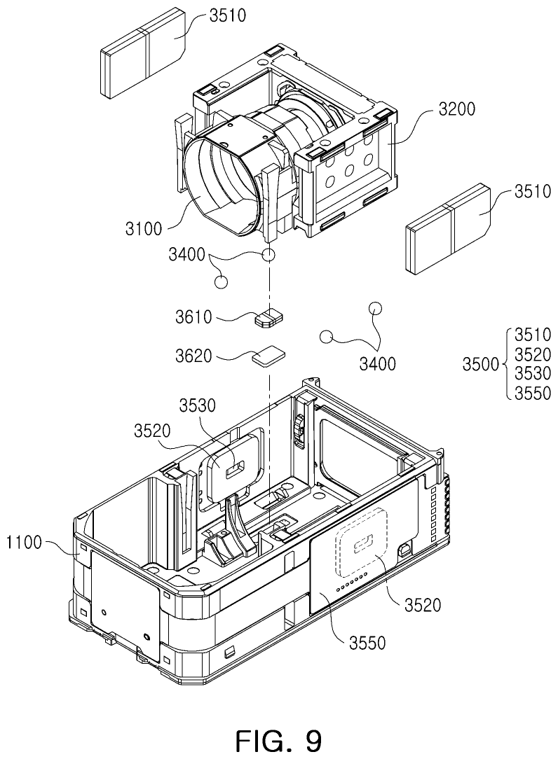

FIG. 8 is an exploded perspective view of a housing and a lens module, in accordance with one or more embodiments, and FIG. 9 is an exploded perspective view of a lens module, in accordance with one or more embodiments.

A lens module 3000, in accordance with one or more embodiments, may include at least one lens, a lens barrel 3100, and a lens holder 3200. The at least one lens may be accommodated in the lens barrel 3100 in the optical axial direction, and the lens barrel 3100 may be accommodated in the lens holder 3200 with the at least one lens accommodated therein. The lens holder 3200 may be accommodated in an internal space of a housing 1100 with the lens barrel 3100 accommodated therein. In an embodiment, the lens barrel 3100 and the lens holder 3200 may be separate components. In another embodiment, the lens barrel 3100 and the lens holder 3200 may be formed integrally.

The lens module 3000 may include a third driving unit 3500 that generates a driving force to move the lens holder 3200 in the optical axis (Z-axis) direction. Since the lens barrel 3100 may be accommodated in the lens holder 3200, the lens barrel 3100 may move together with the lens holder 3200. Additionally, since the at least one lens may be accommodated in the lens barrel 3100, when the lens holder 3200 moves, the at least one lens may also move together with the lens holder 3200.

The third driving unit 3500 may include a third driving magnet 3510 and a third driving coil 3520, arranged to face each other. In an embodiment, the third driving magnet 3510 may be disposed on one side surface or both side surfaces of the lens holder 3200, and the third driving coil 3520 may be mounted on a circuit board 6000 to be disposed on one side surface or both side surfaces of the housing 1100. The third driving magnet 3510 and the third driving coil 3520 may face each other in the second axis (Y-axis) direction.

The third driving magnet 3510 may be magnetized such that a surface thereof facing the third driving coil 3520 has an N pole (or S pole), a neutral region, and an S pole (or N pole) in sequence.

The third driving magnet 3510 may face one third driving coil 3520. The third driving magnet 3510 and the third driving coil 3520 may generate driving forces in a direction (optical axial direction), perpendicular to a direction facing each other through electromagnetic interaction.

A third ball group 3400 may be disposed between the lens holder 3200 and the housing 1100. The third ball group 3400 may include at least three ball members. In an embodiment, the third ball group 3400 may include four ball members.

The four ball members may be spaced apart in a width direction of the lens holder 3200 to support both sides of the lens holder 3200. In an embodiment, a first side and a second side of the lens holder 3200 may be supported by two ball members, respectively. Additionally, in an example, the two ball members disposed on the one side or the other side of the lens holder 3200 may be spaced apart in the optical axial direction.

The four ball members may be accommodated in seventh and eighth guide grooves G41 and G42 provided in the lens holder 3200 and the housing 1100. The seventh and eighth guide grooves G41 and G42 may have a straight line that extends in the optical axial direction. At least one ball member among the four ball members may be supported in at least two points in any one of the seventh and eighth guide grooves G41 and G42. Remaining ball members may be supported in at least one point in the seventh and eighth guide grooves G41 and G42. The four ball members may guide movement of the lens holder 3200 in the optical axial direction while rolling in a state accommodated in the seventh and eighth guide grooves G41 and G42.

The third driving unit 3500 may include a third position sensor 3530 disposed to face the third driving magnet 3510. The third position sensor 3530 may be mounted on the circuit board 6000 together with the third driving coil 3520, and disposed on one side surface or both side surfaces of the housing 1100.

The third position sensor 3530 may be a magnetic sensor that detects a change in magnetic flux passing through the third position sensor 3530 to sense a position of the third driving magnet 3510.

The third position sensor 3530 may face a neutral region of the third driving magnet 3510. When the third position sensor 3530 is provided as a plurality of third position sensors 3530, at least a portion of the plurality of third position sensors 3530 may face the neutral region of the third driving magnet 3510.

Additionally, the third driving unit 3500 may include a third yoke 3550 disposed to face the third driving magnet 3510. The third yoke 3550 may be disposed to cover an external side of the circuit board 6000. Specifically, the third yoke 3550 may be disposed to cover a surface of the circuit board 6000, opposite to a surface on which the third driving coil 3520 and the third position sensor 3530 are mounted.

The third yoke 3550 may be formed of a magnetic material, and may focus magnetic flux of the third driving magnet 3510.

The lens holder 3200 may be supported on the housing 1100. In an embodiment, the lens holder 3200 may include a pulling magnet (or a second magnetic material) 3610, and the housing 1100 may include a pulling yoke (or a third magnetic material) 3620.

The pulling magnet 3610 and the pulling yoke 3620 may be arranged to face each other. The pulling magnet 3610 and the pulling yoke 3620 may generate magnetic attraction. The lens holder 3200 may be supported in close contact with the housing 1100 due to the magnetic attraction of the pulling magnet 3610 and the pulling yoke 3620. The magnetic attraction may occur in the first axial direction in which the pulling magnet 3610 and the pulling yoke 3620 face each other, and the lens holder 3200 may be supported by the housing 1100 in the first axial direction. In another embodiment, positions of the pulling magnet 3610 and the pulling yoke 3620 may be exchanged.

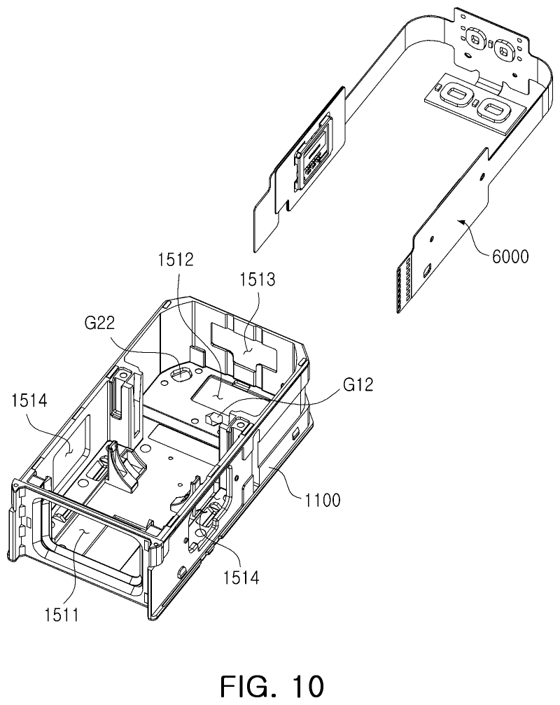

FIG. 10 is an exploded perspective view of a housing and a circuit board, in accordance with one or more embodiments.

A circuit board 6000 on which first to third driving units 2510, 2520, and 3500 are partially arranged may be coupled to a housing 1100. In an example, the circuit board 6000 may be disposed on three side surfaces and a portion of a bottom surface of the housing 1100.

The first to third driving units 2510, 2520, and 3500 respectively including first to third driving coils 2512, 2522, and 3520 may be partially arranged on the circuit board 6000. The housing 1100 may include openings 1152, 1153, and 1154 in a surface onto which the circuit board 6000 is coupled, such that the first to third driving coils 2512, 2522, and 3520 are exposed to an internal space of the housing 1100. Therefore, the first to third driving coils 2512, 2522, and 3520 may directly face first to third driving magnets 2511, 2512, and 3510 arranged in the internal space of the housing 1100, respectively.

In an embodiment, the first to third driving coils 2512, 2522, and 3520 may be arranged on one circuit board 6000, and the circuit board 6000 may be formed of a flexible material such that at least a portion thereof may be bent. In another embodiment, the first to third driving coils 2512, 2522, and 3520 may be arranged on different circuit boards, and may be coupled to the housing 1100.

In an example, a space for arrangement of components involved in driving a reflective module may be secured to improve a degree of freedom of implementation. In particular, as the space for arrangement of components is secured, the components may be arranged to achieve an advantage for smooth operation of the reflective module. Additionally, there may also be effects of reducing a size of a camera module, simplifying a process therefor, and reducing costs thereof.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module, comprising:
a housing;
a rotating holder accommodated in the housing;
a reflective holder on which a first magnetic material and a reflective member configured to change a path of incident light are disposed; and
a driving unit configured to generate a driving force to rotate the reflective member,
wherein the driving unit comprises a first driving magnet disposed on the rotating holder, and a first driving coil disposed on the housing, and
wherein the first driving magnet faces the first driving coil in a first direction, and faces the first magnetic material in a second direction different from the first direction.

2. The reflective module of claim 1, wherein the reflective holder is disposed on the rotating holder.

3. The reflective module of claim 1, wherein the first direction in which the first driving magnet and the first driving coil face each other, and the second direction in which the first driving magnet and the first magnetic material face each other are perpendicular to each other.

4. The reflective module of claim 1, wherein the first driving coil comprises two coils spaced apart in a length direction of the first driving magnet.

5. The reflective module of claim 1, further comprising a first ball group disposed between the housing and the rotating holder,
wherein the first ball group comprises a rotation axis ball that forms a first axis, which is a rotation axis of the rotating holder, and a plurality of guide balls spaced apart from the rotation axis ball and configured to support a rotation of the rotating holder.

6. The reflective module of claim 5, wherein the first driving magnet and the first driving coil are disposed between the rotation axis ball and the plurality of guide balls to be biased toward the rotation axis ball.

7. The reflective module of claim 1, wherein the driving unit comprises a second driving magnet disposed on the reflective holder, and a second driving coil disposed on the housing.

8. The reflective module of claim 7, wherein the reflective holder further comprises an extension portion that extends between the rotating holder and the housing, and the second driving magnet is disposed on the extension portion.

9. The reflective module of claim 1, further comprising a second ball group disposed between the rotating holder and the reflective holder,
wherein the second ball group comprises two ball members spaced apart in a direction of a second axis, which is a rotation axis of the reflective holder.

10. The reflective module of claim 1, wherein the rotating holder is supported by the housing in the first direction, and the reflective holder is supported by the rotating holder in the second direction different from the first direction.

11. A camera module, comprising:
a housing;
a reflective module accommodated in the housing, and comprising a reflective member configured to change a path of incident light; and
a lens module accommodated in the housing, and comprising at least one lens disposed in a direction, parallel to an optical axis,
wherein the reflective module comprises a reflective holder on which the reflective member is disposed, and a rotating holder on which the reflective holder is disposed, and
wherein a magnet, configured to generate an attractive force with regard to the reflective holder in a first direction, parallel to the optical axis, and configured to generate an attractive force with regard to the housing in a second direction, parallel to a first axis, perpendicular to the optical axis, is disposed on the rotating holder.

12. The camera module of claim 11, wherein the magnet faces a first magnetic material in the first direction, parallel to the optical axis, and faces a first yoke in the second direction, parallel to the first axis.

13. The camera module of claim 12, wherein the first magnetic material is a pulling yoke that is disposed on the reflective holder.

14. The camera module of claim 12, wherein the magnet faces a coil in the second direction, parallel to the first axis.

15. The camera module of claim 11, wherein the rotating holder is configured to rotate about the first axis,
wherein a rotation axis ball that forms the first axis and a plurality of guide balls spaced apart from the rotation axis ball are disposed between the rotating holder and the housing, and
wherein the magnet is disposed between the rotation axis ball and the plurality of guide balls to be biased toward the rotation axis ball in a direction of the optical axis.

16. The camera module of claim 11, wherein the reflective holder is configured to rotate about a second axis, perpendicular to the optical axis and the first axis, and
wherein a plurality of ball members spaced apart in a direction of the second axis are disposed between the reflective holder and the rotating holder.

17. The camera module of claim 11, wherein the lens module is configured to move in a direction of the optical axis, and
wherein a plurality of ball members that support a movement of the lens module in the direction of the optical axis are disposed between the lens module and the housing.
